(19) United States
(12) Patent Application Publication
(10) Pub. No.: US 2007/0152589 A1
(43) Pub. Date: Jul. 5, 2007

(54) Plasma display panel

(76) Inventors: Hyun Kim, Suwon-si (KR); Kyoung-Doo Kang, Suwon-si (KR); Se-Jong Kim, Suwon-si (KR); Hyun Soh, Suwon-si (KR); Yun-Hee Kim, Suwon-si (KR); Jin-Won Han, Suwon-si (KR)

Correspondence Address: Robert E. Bushnell, Suite 300, 1522 K Street, N. W., Washington, DC, 20005, US

(21) Appl. No.: 11/511,297

(22) Filed: Aug. 29, 2006

(30) Foreign Application Priority Data
Dec. 31, 2005 (KR) 10-2005-0136230

(51) Int. Cl. H01J 17/49

(52) U.S. Cl. 313/586; 313/582

(57) ABSTRACT

A plasma display panel that reduces a discharge voltage and increases discharge stability, includes: a rear substrate; a front substrate disposed to oppose the rear substrate; barrier ribs disposed between the front substrate and the rear substrate and partitioning a plurality of discharge cells; pairs of sustain electrodes disposed on the front substrate opposing the rear substrate, and including bus electrodes disposed in a direction and a plurality of projection electrodes electrically connected to the bus electrodes in each of discharge cells and projected inward each of the discharge cells; a front dielectric layer covering the sustain electrodes and having grooves corresponding to each of the discharge cells; address electrodes extending to cross the sustain electrodes and disposed on the rear substrate opposing the front substrate; a rear dielectric layer disposed to cover the address electrodes; phosphor layers disposed in the discharge cells; and a discharge gas stored in the discharge cells, wherein the width of the projection electrodes opposing inward the discharge cells is wider than the width of the grooves.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on 31 Dec. 2005 and there duly assigned Serial No. 10-2005-0136230.

### BACKGROUND OF THE INVENTION

1. Field of the Invention

The present invention relates to a plasma display panel, and more particularly, to a plasma display panel that reduces a discharge voltage.

2. Description of the Related Art

Plasma display panels (PDP) which have replaced conventional cathode ray tube (CRT) display devices display desired images using visible rays generated by sealing discharge gas and applying discharge voltage between two substrates on which a plurality of electrodes are formed to generate vacuum ultraviolet rays and exciting phosphor on which the vacuum ultraviolet rays are formed in a predetermined pattern.

A conventional alternating current (AC) type plasma display panel includes an upper plate that displays an image to a user and a lower plate that is combined parallel with the upper substrate. A plurality of pairs of discharge sustain electrodes including Y electrodes and X electrodes are disposed in a front substrate of the upper plate. Address electrodes are disposed in a rear substrate of the lower plate that opposes the front substrate and cross the Y electrodes and the X electrodes. The Y electrodes and the X electrodes include transparent electrodes and bus electrodes, respectively. A pair of the Y electrode and the X electrode and the address electrode crossing the pair of the Y electrodes and the X electrodes form a unit discharge cell, which is a discharge unit. A front dielectric layer and a rear dielectric layer are formed on the front substrate and the rear substrate, respectively, to bury each of the electrodes. A protective layer formed of MgO is formed on the front dielectric layer. Barrier ribs that maintain a discharge distance and prevent an electrical and optical cross talk between discharge cells are formed in a front surface of the rear dielectric layer. Phosphor layers are coated in both sides of the barrier ribs and in a front surface of the rear dielectric layer where the barrier ribs are not formed.

The conventional alternating current (AC) type plasma display panel must increase a distance G between the Y electrodes and the X electrodes in order to improve brightness and luminous efficiency, because an increased discharge area results in active generation of a plasma discharge. However, as the distance G increases, a voltage for starting a discharge is also increased. In this regard, a rated voltage of electronic devices for driving the Y electrodes and the X electrodes increases, which causes an increase in costs.

### SUMMARY OF THE INVENTION

The present invention provides a plasma display panel that reduces a discharge voltage.

The present invention also provides a plasma display panel that increases luminous efficiency.

The present invention also provides a plasma display panel that increases discharge stability.

According to an aspect of the present invention, there is provided a plasma display panel including: a substrate; pairs of sustain electrodes disposed on the substrate, and including bus electrodes disposed in a direction and a plurality of projection electrodes electrically connected to the bus electrodes in each of discharge cells and projected inward each of the discharge cells; and dielectric layers covering the sustain electrodes and having grooves corresponding to each of the discharge cells, wherein the width of the projection electrodes opposing inward the discharge cells is wider than the width of the grooves.

According to another aspect of the present invention, there is provided a plasma display panel, including: a rear substrate; a front substrate disposed to oppose the rear substrate; barrier ribs disposed between the front substrate and the rear substrate and partitioning a plurality of discharge cells; pairs of sustain electrodes disposed on the front substrate opposing the rear substrate, and including bus electrodes disposed in a direction and a plurality of projection electrodes electrically connected to the bus electrodes in each of discharge cells and projected inward each of the discharge cells; a front dielectric layer covering the sustain electrodes and having grooves corresponding to each of discharge cells; address electrodes extending to cross the sustain electrodes and disposed on the rear substrate opposing the front substrate; a rear dielectric layer disposed to cover the address electrodes; phosphor layers disposed in the discharge cells; and a discharge gas stored in the discharge cells, wherein the width of the projection electrodes opposing inward the discharge cells is wider than the width of the grooves.

The grooves may be formed between the pairs of sustain electrodes. The grooves are formed between pairs of the projection electrodes. The projection electrodes disposed in each of the discharge cells and the grooves are arranged in line.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a conventional alternating current (AC) type plasma display panel;

FIG. 2 is a partially exploded perspective view of a plasma display panel according to an embodiment of the present invention;

FIG. 3 is a partial cross-sectional view taken along a line III-III of FIG. 2, according to an embodiment of the present invention;

FIG. 4 is a layout diagram of discharge cells, electrodes, and grooves illustrated in FIG. 2, according to an embodiment of the present invention; and

FIG. 5 is a layout diagram corresponding to the layout diagram illustrated in FIG. 4 except that electrodes have a different shape from the electrodes illustrated in FIG. 4.

### DETAILED DESCRIPTION OF THE INVENTION

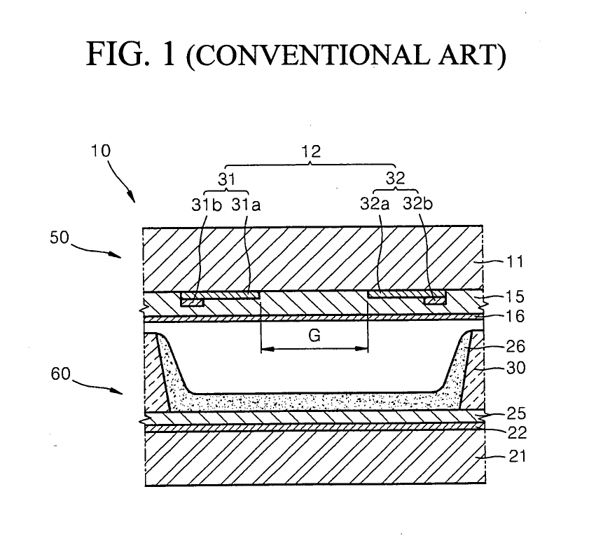

FIG. 1 is a cross-sectional view of a conventional alternating current (AC) type plasma display panel 10. Referring to FIG. 1, the plasma display panel 10 includes an upper plate 50 that displays an image to a user and a lower plate 60 that is combined parallel with the upper substrate 50. A plurality of pairs of discharge sustain electrodes 12 including Y electrodes 31 and X electrodes 32 are disposed in a front substrate 11 of the upper plate 50. Address electrodes 22 are disposed in a rear substrate 21 of the lower plate 60 that opposes the front substrate 11 and cross the Y electrodes 31 and the X electrodes 32. The Y electrodes 31 and the X electrodes 32 include transparent electrodes 31a and 32a and bus electrodes 31b and 32b, respectively. A pair of the Y electrode 31 and the X electrode 32 and the address electrode 22 crossing the pair of the Y electrodes 31 and the X electrodes 32 form a unit discharge cell, which is a discharge unit. A front dielectric layer 15 and a rear dielectric layer 25 are formed on the front substrate 11 and the rear substrate 21, respectively, to bury each of the electrodes. A protective layer 16 formed of MgO is formed on the front dielectric layer 15. Barrier ribs 30 that maintain a discharge distance and prevent an electrical and optical cross talk between discharge cells are formed in a front surface of the rear dielectric layer 25. Phosphor layers 26 are coated in both sides of the barrier ribs 30 and in a front surface of the rear dielectric layer 25 where the barrier ribs 30 are not formed.

The conventional alternating current (AC) type plasma display panel 10 must increase a distance G between the Y electrodes 31 and the X electrodes 32 in order to improve brightness and luminous efficiency, because an increased discharge area results in active generation of a plasma discharge. However, as the distance G increases, a voltage for starting a discharge is also increased. In this regard, a rated voltage of electronic devices for driving the Y electrodes 31 and the X electrodes 32 increases, which causes an increase in costs.

Hereinafter, the present invention will be described more fully with reference to the accompanying drawings, in which exemplary embodiments of the invention are shown.

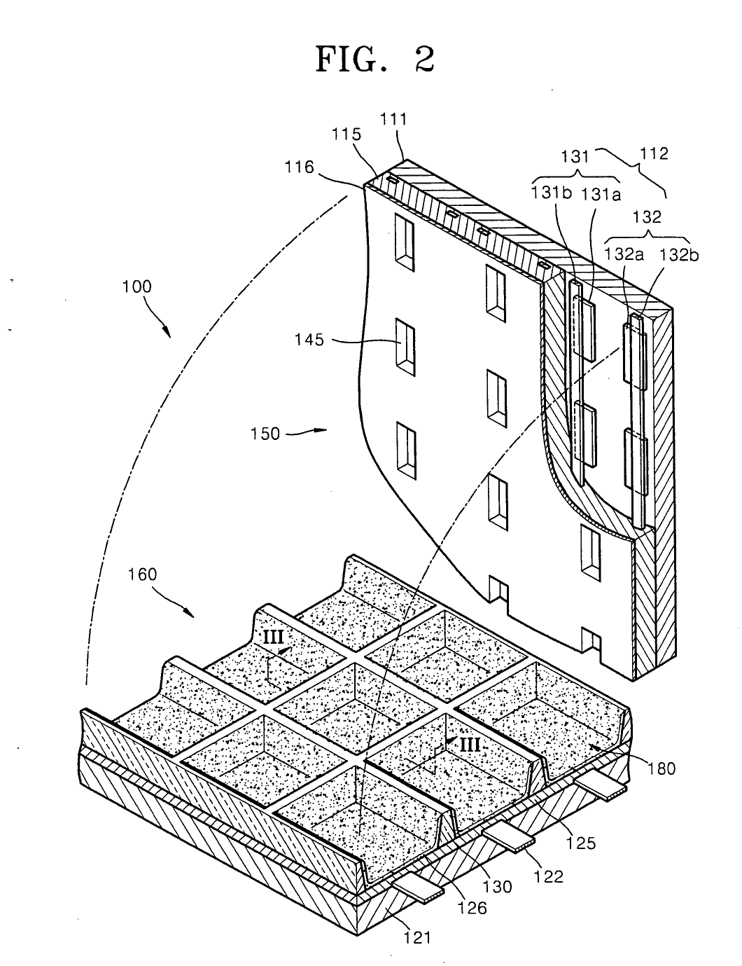

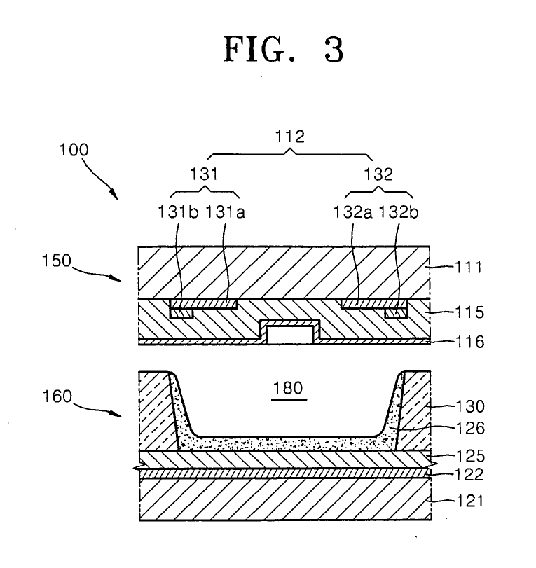

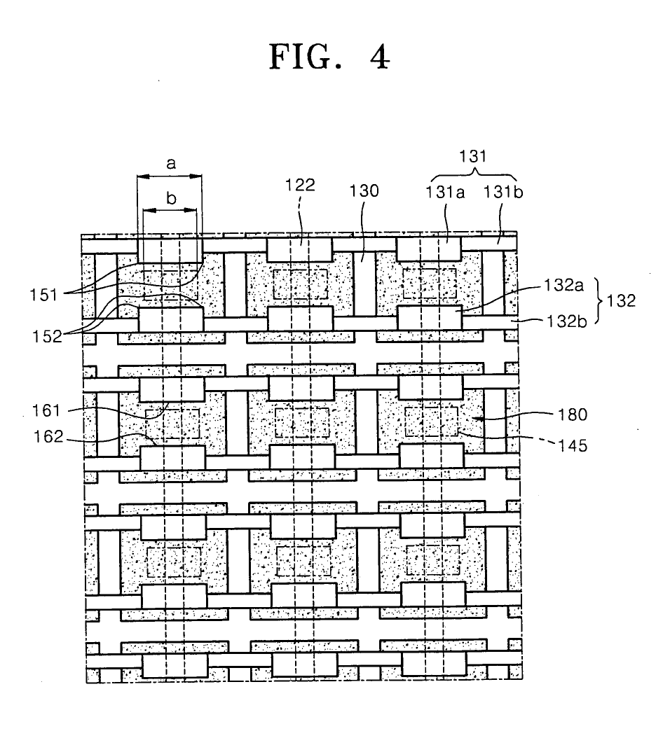

FIG. 2 is a partially exploded perspective view of a plasma display panel 100 according to an embodiment of the present invention. FIG. 3 is a partial cross-sectional view taken along a line III-III of FIG. 2, according to an embodiment of the present invention. FIG. 4 is a layout diagram of discharge cells 180, electrodes 131, 132, and 122, and grooves 145 illustrated in FIG. 2, according to an embodiment of the present invention. Like reference numerals in the drawings denote like elements.

Referring to FIG. 2, the plasma display panel I 00 includes an upper plate 150 and a lower plate 160 combined parallel with the upper plate 150. The upper plate 150 includes a front substrate 111, a front dielectric layer 115, pairs of sustain electrodes 112, and a protective layer 116. The lower plate 160 includes a rear substrate 121, address electrodes 122, a rear dielectric layer 125, barrier ribs 130, and phosphor layers 126.

The front substrate 111 and the rear substrate 121 are spaced apart from each other by a predetermined gap and define discharge spaces therebetween. The front substrate 111 and the rear substrate 121 may be formed of a material having excellent light transmission properties such as glass. However, the front substrate 111 and/or the rear substrate 121 can be colored in order to increase the bright room contrast.

The barrier ribs 130 are disposed between the front substrate 111 and the rear substrate 121, more particularly, on the rear dielectric layer 125. The barrier ribs 130 partition the discharge spaces into a plurality of discharge cells 180 and prevent optical and electrical cross talk between the discharge cells 180. Referring to FIG. 2, the barrier ribs 130 partition the discharge cells 180 having rectangular cross-sections arranged in a matrix but the present invention is not limited thereto. In detail, the discharge cells 180 can have polygonal cross sections such as triangular cross sections, tetragonal cross sections, pentagonal cross sections, etc., circular cross sections, oval cross sections, or open-shaped such as a stripe. The discharge cells 180 can also have delta type arrangements or waffle type arrangements.

The pairs of sustain electrodes 112 are disposed on the front substrate 111 opposing the rear substrate 121. Each of the pairs of sustain electrodes 112 is a pair of sustain electrodes 131 and 132 disposed in the rear of the front substrate 111 to generate a sustain discharge. The pairs of sustain electrodes 112 are disposed parallel to each other by a predetermined gap on the front substrate 111. One of each of the pairs of sustain electrodes 112 is an X electrode 131 and serve as a common electrode, and the other one of each of the pairs is a Y electrode 132 that serve as a scan electrode. In the current embodiment of the present invention, the pairs of sustain electrodes 112 are directly disposed on the front substrate 111 but the present invention is not limited thereto. For example, the pairs of sustain electrodes 112 can be spaced apart from each other by a predetermined gap in a direction from the front substrate 111 to the rear substrate 121.

The X electrodes 131 and the Y electrodes 132 include projection electrodes 131 a and 132a and bus electrodes 131b and 132b, respectively. The projection electrodes 131a and 132a are formed of a transparent material which is a conductor generating a discharge and does not prevent light emitted from the phosphor layers 126 from forwarding the front substrate 111. The transparent material is indium tin oxide (ITO), etc. However, the projection electrodes 131a and 132a formed of ITO have much driving power consumption and a slow response speed due to a large voltage drop in a length direction. To address these problems, the bus electrodes 131b and 132b, formed of a metal material and having a narrow width, are disposed on the projection electrodes 131a and 132a. The bus electrodes 131b and 132b can have a single-layer structure using metal such as Ag, Al, or Cu, and have a multi-layer structure such as Cr/Al/Cr, etc. The projection electrodes 131a and 132a and bus electrodes 131b and 132b can be formed using a photo-etching method, a photolithography method, etc.

With regard to the shape and arrangement of the X electrodes 131 and the Y electrodes 132, the bus electrodes 131b and 132b are spaced apart from each other by a predetermined gap in the unit discharge cells 180, and extend to cross the discharge cells 180 disposed in a certain direction. As described above, the projection electrodes 131a and 132a are electrically connected to each one of the bus electrodes 131b and 132b. More particularly, the rectangular projection electrodes 131a and 132a are discontinuously arranged in each of the discharge cells 180. One side of each of the projection electrodes 131a and 132a is connected to the bus electrodes 131b and 132b, and another side is disposed toward the center of the discharge cells 180.

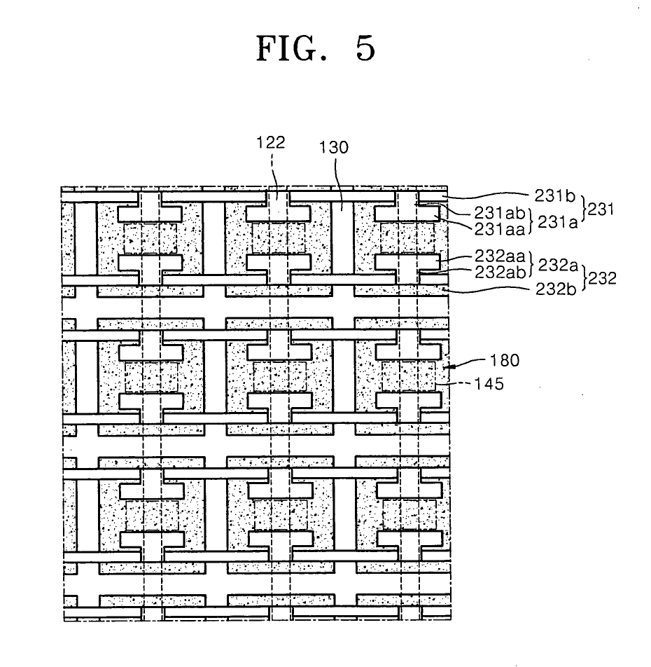

However, the projection electrodes 131a and 132a can have a variety of shapes. Hammer-shaped X electrodes 231 and Y electrodes 232 are illustrated in FIG. 5. Referring to FIG. 5, the X electrodes 231 and the Y electrodes 232 include a plurality of projection electrodes 231a and 232a and bus electrodes 231b and 232b, respectively. The projection electrodes 231a of the X electrodes 231 include discharge units 231aa which are spaced apart from the bus electrodes 231b of the X electrodes 231 inward the discharge cells 180, and connection units 231ab which connect the discharge units 231aa and the bus electrodes 231b of the X electrodes. The projection electrodes 232a of the Y electrodes 232 include discharge units 232aa which are spaced apart from the bus electrodes 232b of the Y electrodes 232 and inward with respect to the discharge cells 180, and connection units 232ab which connect the discharge units 232aa and the bus electrodes 232b of the Y electrodes. Since the discharge units 231aa and 232aa of the X electrodes 231 and Y electrodes 232, respectively, maintain a short gap therebetween, a discharge voltage can be reduced. Also, since the structure of the discharge units 231aa and 232aa can reduce areas of the projection electrodes 231a and 232a, transmission rate of visible light can be improved.

Referring to FIGS. 2 and 3, the front dielectric layer 115 is formed on the front substrate 111 to bury the pairs of sustain electrodes 112. The front dielectric layer 115 prevents direct conduction between the adjacent X electrodes 131 and Y electrodes 132, and simultaneously the X electrodes 131 and Y electrodes 132 from being damaged due to direct collisions of charge particles or electrons with the X electrodes 131 and Y electrodes 132. Also, the front dielectric layer 115 induces charges and is formed of PbO, B₂O₃, SiO₂, etc.

Grooves 145 are formed in the front dielectric layer 115 between the pairs of the X electrodes 131 and the Y electrodes 132. The grooves 145 have a predetermined depth, which is determined based on possibility of damage to the front dielectric layer 115, the arrangement of wall charges, size of a discharge voltage, etc. For example, the grooves 145 can be formed to expose the front substrate 111.

Referring to FIGS. 2 through 4, each of the grooves 145 is formed in each of the discharge cells 180. Since the thickness of the front dielectric layer 115 is reduced by the grooves 145, the forward transmission rate of visible light is improved. In the current embodiment of the present invention, the grooves 145 substantially have rectangular cross sections but the present invention is not limited thereto and can have a variety of shapes.

As described above, the projection electrodes 131a and 132a of the X electrodes 131 and the Y electrodes 132 are discontinuously arranged in each one of the discharge cells 180. In this structure, an electric field is focused on angular points 151 and 152 of the projection electrodes 131a and 132a disposed inside the discharge cells 180 during a plasma discharge. However, if a discharge is focused on the angular points 151 and 152, the electric field is not uniformly formed between the projection electrodes 131a and 132a of the X electrodes 131 and the Y electrodes 132 that generate the discharge, which can cause unintended discharge instability in connection with coating characteristics of the protective layer 116 and the phosphor layers 126, non-uniform shapes of the barrier ribs 130, etc. Moreover, the grooves 145 formed between the X electrodes 131 and the Y electrodes 132 can deteriorate the discharge instability. This will be described in detail. Since the electric field is focused on the grooves 145 and a discharge path is reduced, the discharge voltage is reduced. Therefore, when the grooves 145 are formed in portions of the front dielectric layer 115 corresponding to the angular points 151 and 152 of the projection electrodes 131a and 132a, the discharge instability can be deteriorated due to voltage margin instability, non-uniformly formed wall charges, and an asymmetrical discharge.

To address these problems, referring to FIG. 4, the width “a” of the projection electrodes 131a and 132a opposing inward the discharge cells 180 is wider than the width “b” of the grooves 145. The grooves 145 are formed between the pairs of projection electrodes 131a and 132a. The projection electrodes 131a and 132a and the grooves 145 disposed in each of the discharge cells 180 are arranged in line. Therefore, since the grooves 145 are not formed in portions corresponding to the angular points 151 and 152 of the projection electrodes 131 a and 132a, the discharge instability can be reduced. In particular, although the angular points 151 and 152 have a large electric field and corners 161 and 162 have a small electric field due to the projection electrodes 131a and 132a, since the electric field of the corners 161 and 162 is reinforced by the grooves 145, the whole uniformity of the electric field is considerably increased. Therefore, since the discharge is stabilized and actively generated, luminous efficiency is increased.

The plasma display panel 100 may further include the protective layer 116 covering the front dielectric layer 1 5. The protective layer 116 prevents the front dielectric layer 1 5 from being damaged due to collisions of charge particles and electrons with the front dielectric layer 115 during the discharge. Also, the protective layer 116 emits a large amount of secondary electrons during the discharge to actively generate the plasma discharge. The protective layer 116 is formed of a material having a high coefficient of secondary electrons emission and high transmission rate of visible light. The protective layer 116 is formed using sputtering, electronic beam deposition, etc., after the front dielectric layer 115 is formed.

The address electrodes 122 are disposed on the rear substrate 121 opposing the front substrate 111. The address electrodes 122 extend over the discharge cells 180 to cross the X electrodes 131 and the Y electrodes 132.

The address electrodes 122 generate an address discharge to facilitate a sustain discharge between the X electrodes 131 and the Y electrodes 132, and, more particularly, reduce a voltage for generating the sustain discharge. The address discharge is generated between the Y electrodes 132 and the address electrodes 122. If the address discharge is terminated, wall charges are accumulated in the Y electrodes 132 and the X electrodes 131, so that the sustain discharge between the X electrodes 131 and the Y electrodes 132 can be facilitated.

A rear dielectric layer 125 is formed on the rear substrate 121 to bury the address electrodes 122. The rear dielectric layer 125 is formed of a dielectric substance capable of preventing the address electrodes 122 from being damaged due to collisions of charge particles or electrons with the address electrodes 122 and inducing charges. The dielectric substance is PbO, B₂O₃, SiO₂, etc.

The red, green, and blue light emitting phosphor layers 126 are disposed in both sides of the barrier ribs 130 formed on the rear dielectric layer 125 and in the whole surface of the rear dielectric layer 125 where the barrier ribs 130 are not formed. The phosphor layers 126 have a component generating visible light with ultraviolet rays. That is, a phosphor layer formed in a red light-emitting discharge cell has a phosphor such as Y(V,P)O₄:Eu, a phosphor layer formed in a green light-emitting discharge cell has a phosphor such as Zn₂SiO₄:Mn, YBO₃:Tb, and a phosphor layer formed in a blue light-emitting discharge cell has a phosphor such as BAM:Eu.

A discharge gas such as Ne, Xe, or a mixture thereof is sealed in the discharge cells 180. In this state, the front substrate 111 and the rear substrate 121 are sealed to be connected by a sealing member such as a frit glass formed in edges of the front substrate 111 and the rear substrate 121.

The operation of the plasma display panel 100 having the above structure will now be described.

A plasma discharge generated in the plasma display panel 100 is divided into the address discharge and the sustain discharge. The address discharge is generated by applying an address discharge voltage between the address electrodes 122 and the Y electrodes 132, so that the discharge cells 180 where the sustain discharge is generated are selected.

A sustain voltage is applied between the X electrodes 131 and the Y electrodes 132 of the selected discharge cells 180. At this time, an electric field is focused on the grooves 145 formed in the front dielectric layer 115 and thus a discharge voltage is reduced. Because a discharge path between the X electrodes 131 and the Y electrodes 132 is reduced, a strong magnetic field is generated to focus the electric field on the discharge path, and charges, charge particles, excited species, etc., have a high density. In particular, since the pairs of the projection electrodes 131a and 132a have a uniform electric field distribution due to electric field distributions according to the shape of the projection electrodes 131a and 132a and the grooves 145, discharge stability is increased.

An energy level of the discharge gas excited by the sustain discharge is reduced, thereby discharging ultraviolet rays. The ultraviolet rays excite the phosphor layers 126 coated in the discharge cells 180, such that an energy level of the excited phosphor layers 126 is reduced to discharge visible light which transmits the front dielectric layer 115 and the front substrate 111 and forms an image recognized by a user.

According to the plasma display panel of the present invention, since an electric field is focused on grooves and a discharge path is reduced, a discharge voltage is reduced and luminous efficiency is increased.

Since an electric field distribution is uniform between pairs of projection electrodes due to electric field distributions according to shapes of the projection electrodes and the grooves, discharge stability is increased and a high effective discharge can be formed.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a substrate;
pairs of sustain electrodes disposed on said substrate, and each one of said pairs of sustain electrodes comprising a bus electrode disposed in a certain direction and a projection electrode electrically connected to said bus electrode in each one of a plurality of discharge cells and projected inward with each one of the discharge cells; and
dielectric layers covering said sustain electrodes and including grooves corresponding to each one of the discharge cells,
a width of said projection electrodes opposing inward the discharge cells being wider than a width of the grooves.

2. The plasma display panel of claim 1, wherein the grooves are formed between said pairs of sustain electrodes.

3. The plasma display panel of claim 2, wherein the grooves are formed between said pairs of the projection electrodes.

4. The plasma display panel of claim 3, wherein said projection electrodes disposed in each of the discharge cells and the grooves are arranged in line.

5. The plasma display panel of claim 1, wherein the grooves substantially include rectangular cross-sections.

6. The plasma display panel of claim 1, wherein the grooves are formed to expose said substrate.

7. The plasma display panel of claim 1, wherein one groove is formed in each of the discharge cells.

8. The plasma display panel of claim 1, wherein said projection electrodes are formed of a transparent material.

9. A plasma display panel, comprising:
a rear substrate;
a front substrate disposed to oppose said rear substrate;
barrier ribs disposed between said front substrate and said rear substrate and partitioning a plurality of discharge cells;
pairs of sustain electrodes disposed on said front substrate opposing said rear substrate, and comprising bus electrodes disposed in a direction and a plurality of projection electrodes electrically connected to said bus electrodes in each one of the discharge cells and projected inward with each one of the discharge cells;
a front dielectric layer covering the sustain electrodes and including grooves corresponding to each one of the discharge cells;
address electrodes extending to cross said sustain electrodes and disposed on said rear substrate opposing said front substrate;
a rear dielectric layer disposed to cover said address electrodes;
phosphor layers disposed in the discharge cells; and
a discharge gas stored in the discharge cells,
a width of said projection electrodes opposing inward with the discharge cells being wider than a width of the grooves.

10. The plasma display panel of claim 9, wherein the grooves are formed between said pairs of sustain electrodes.

11. The plasma display panel of claim 10, wherein the grooves are formed between pairs of said projection electrodes.

12. The plasma display panel of claim 11, wherein said projection electrodes disposed in each of the discharge cells and the grooves are arranged in a line.

13. The plasma display panel of claim 9, wherein the grooves substantially include rectangular cross-sections.

14. The plasma display panel of claim 9, wherein the grooves are formed to expose said front substrate.

15. The plasma display panel of claim 9, wherein one groove is formed in each one of the discharge cells.

16. The plasma display panel of claim 9, wherein said projection electrodes are formed of a transparent material.

17. A plasma display panel, comprising:
a substrate;
pairs of sustain electrodes disposed on said substrate, and each one of said pairs of sustain electrodes comprising a bus electrode disposed in a certain direction and a projection electrode electrically connected to said bus electrode in each of one of a plurality of discharge cells and projected inward with each one of the discharge cells; and
a separate dielectric layer covering said sustain electrodes and including a plurality of grooves of a certain depth corresponding to at least a substantial number of the discharge cells,
a width of any portion of said projection electrodes opposing inward the discharge cells being wider than a width of any portion of the grooves.

18. The plasma display panel of claim 17, wherein:
said separate dielectric layer comprising the plurality of grooves corresponding to each one of the discharge cells and formed between said pairs of sustain electrodes, with the width of said projection electrodes opposing inward the discharge cells being wider than the widths of each one of the grooves, and
each one of said projection electrodes being directly connected to each one of said bus electrodes, said projection electrodes being arranged in each one of the discharge cells with one side being directly connected to the bus electrodes and the other being disposed toward the center of each one of the discharge cells.

19. The plasma display panel of claim 17, wherein each one of said projection electrodes comprise:
a discharge unit spaced apart from a corresponding bus electrode inward with the discharge cells; and
a connection unit connecting the discharge units and said bus electrodes.

20. The plasma display panel of claim 17, wherein a portion of said separate dielectric layer with the grooves having less thickness than the portion of said separate dielectric layer without the grooves, with the grooves not being formed at portions corresponding to angular points of said projection electrodes, and the grooves are formed between the pairs of projection electrodes with the projection electrodes and grooves being disposed in each one of the discharge cells in line.
